(19) United States
(12) Patent Application Publication
(10) Pub. No.: US 2006/0157647 A1
(43) Pub. Date: Jul. 20, 2006

(54) Multidimensional liquid chromatography/spectrometry

(75) Inventors: Gary Siuzdak, San Diego, CA (US); Zhouxin Shen, San Diego, CA (US)

Correspondence Address: DAVID W HIGHET VP AND CHIEF IP COUNSEL;BECTON DICKINSON AND COMPANY, 1 BECTON DRIVE, MC110, FRANKLIN LAKES, NJ, 07417-1880, US

(73) Assignee: Becton, Dickinson and Company, Franklin Lakes, NJ (US)

(21) Appl. No.: 11/036,160

(22) Filed: Jan. 18, 2005

(51) Int. Cl. H01J 49/04; G01N 30/72; G01N 30/62

(52) U.S. Cl. 250/288; 324/307; 210/656

(57) ABSTRACT

A liquid chromatography configuration providing at least three dimensions of separation coupled with spectrometry greatly improves the ability to detect ions present in samples, including complex biological samples such as blood. Liquid chromatography columns in one embodiment are connected with an in-line trapping column the alternately communicates with the second and third liquid chromatography columns. The liquid chromatography columns are operably connected either to a mass spectrometer (MS) or a nuclear magnetic resonance (NMR) spectrometer. The improved dynamic range of detection allows a method of detecting molecular components present in complex biological samples that serve as biomarkers for a disease state, such as sepsis.

### FIELD OF THE INVENTION

The present invention pertains to an apparatus and method to analyze the proteome. A combination of three-dimensional liquid chromatography, coupled with spectrometry, improves the ability to analyze proteins in minute quantities from complex biological sources such as blood.

### BACKGROUND OF THE INVENTION

Applicants make no admission that any of the following cited articles and methods are prior art, and they expressly reserve the right to demonstrate, where appropriate, that these articles and methods do not constitute prior art under the applicable statutory provisions.

Changes in protein expression in complex biological fluids such as blood reflect changes in the physiological response during disease states. For example, changes in cytokine levels reflect in part the body's response to inflammatory stimuli. Understanding how specific protein levels respond to alterations in physiological conditions therefore can be useful in establishing relevant diagnostic markers or better targets for therapeutic intervention. A barrier toward this understanding is the complexity of the biological material used as starting material to detect the relevant protein levels. It is estimated that the human proteome contains hundreds of thousands of varieties of proteins produced by the estimated 30,000 genes of the human genome. The success of a method of detecting and measuring the concentration of these proteins therefore depends in part on the ability to resolve the biological sample into its myriad component proteins. (See Wolters et al., Anal. Chem. 73: 5683-90 (2001).)

Another barrier facing the measurement of the proteome is the large “dynamic range” of protein concentrations in the proteome. That is, clinically relevant proteins can have concentration ranges in biological fluids that span over 10 orders of magnitude. For instance, the concentration of albumin in plasma is approximately 35-50×10⁹ pg/mL, while the level of such important regulatory molecules as interleukin-6 may be as low as 0-5 pg/mL. (See Anderson et al., Mol. Cel. Proteomics 2: 50 (January 2003), available at http:/www.mcponline.org.)

Further, proteins in biological fluids must be measured both reproducibly and robustly, if a protein is to be validated as a marker for a physiological process. See Wolters. That is, different laboratories must be able to detect the same protein in multiple experiments using a particular method, if that method is to be useful in diagnostic application. Preferably, the method should be amenable to automation for high-throughput studies and should require minimal manipulation of the sample material prior to separation of its component molecules.

One approach to solving these problems is an automated multidimensional protein identification technology (MudPIT), which combines multidimensional fractionation of a biological sample using liquid chromatography (LC), followed by analysis of the fractionated sample by mass spectrometry (MS). (See Wolters.) Liquid chromatography is provided by a reversed-phase (RP) column and strong cation-exchange (SCX) column that are arrayed in tandem and configured to feed the eluate directly to an electrospray ionization (ESI) mass spectrometer. Although not completely orthogonal, the RP column and SCX column separate molecules on the basis of different characteristics (hydrophobicity and charge, respectively), providing two “dimensions” of molecular separation. (Id.) Reproducible separation of the molecules within the sample prior to their resolution by mass spectrometry reduces the complexity of the ions produced in each mass spectrum, thereby reducing the occurrence of overlapping peaks and shoulders from ions having similar mass-to-charge (m/z) ratios and increasing the number of molecules that can be resolved in each spectra. Improved resolution increases the dynamic range, in part by the ability to resolve rare molecular species from the large peaks of the more abundant species.

The use of two dimensional LC (LC/LC) can be combined with a mass spectrometer that itself is configured in multiple dimensions (MS/MS or MSⁿ), for example, by the use of triple quadrupole MS or hybrid quadrupole/time-of-flight MS. (See, e.g., Morris et al., Rapid Commun. Mass Spectrom. 10: 889-96 (1996).) The resulting MudPIT apparatus, which is an “LC/LC/MS/MS” configuration, provides a peak capacity of approximately 23,000 ions, with reproducibility within 0.5% and a dynamic range of 10,000:1 for a complex mixture of tens of thousands of components.

Despite these results, further improvement is required to analyze such complex biological fluids as blood or plasma, which contain considerably more than tens of thousands of components and require a dynamic range of sensitivity about four orders of magnitude higher than achieved with MudPIT. The ability to analyze such complex biological fluids, preferably to obtain an unbiased sample of the entire proteome in such samples, is expected to contribute enormously to the ability to diagnose disease and other relevant physiological conditions.

### SUMMARY OF THE INVENTION

To that end, according to one aspect of the invention, an apparatus is provided that improves the number of molecules that may be analyzed from a sample and the dynamic range of detection, especially from complex biological fluids. An apparatus comprising a configuration of liquid chromatography columns provides multidimensional liquid chromatography (“LCⁿ”). The LCⁿ apparatus is combined with either mass spectrometry (MS) or nuclear magnetic resonance (NMR) spectrometry to create a configuration with an improved ability to resolve low-abundance ions in a sample, such as a biological sample. In one embodiment, the LCⁿ apparatus is interfaced with an eletrospray ionization ion trap tandem mass spectrometry to allow rapid mass spectral analysis of fractions as they are eluted from the LCⁿ apparatus. According to another aspect of the invention, a method is provided of using the apparatus to detect ions present in samples, including complex biological samples. In one embodiment, the present apparatus is used to detect a plurality of ions that serve as biomarkers for a disease state, such as sepsis. The ions that are detected in the present method may include ions from proteins present at very low concentrations in plasma.

A liquid chromatograph spectrometer of the present invention comprises a first LC column comprising (a) a first resin connected in tandem to a second LC column having an outlet and comprising a second resin, (b) a third LC column having an outlet and an inlet, and comprising a third resin, and (c) a spectrometer operably connected to the third column outlet; where the first, second and third resins have distinct separation characteristics, and where the third LC column inlet is operably connected to the second LC column outlet. The present spectrometer may comprise an electrospray ionization mass spectrometer, a matrix-assisted laser desorption ionization time-of-flight mass spectrometer, a surface-enhanced laser desorption/ionization time-of-flight mass spectrometer, a desorption/ionization on silicon spectrometer, a secondary ion mass spectrometer, a quadrupole time-of-flight spectrometer, an atmospheric pressure chemical ionization mass spectrometer, an atmospheric pressure photoionization mass spectrometer, a quadrupole spectrometer, a fourier transform mass spectrometer, or an ion trap. Alternatively, the spectrometer may be a NMR spectrometer.

The operable connection between the second and third LC columns liquid chromatograph in the spectrometer above may comprise a trapping column containing a trapping resin, which alternately communicates with the second LC column outlet and the third LC column inlet. In this embodiment, a fraction of molecules eluted from the second resin is capable of being contained within the trapping column when the trapping column communicates with the second LC column, and the trapping resin and third resin bind the molecule on the basis of the same physical characteristic. This operable connection may further comprise an automated mechanism for moving the trapping column from the second column outlet to the third column inlet.

In the liquid chromatograph above, the liquid chromatograph spectrometer may comprise four or more operably linked LC columns, each possessing a distinct separation characteristic. The third LC column may be an analytical column that fractionates molecules with a resolution higher than that achieved by the first or second LC columns. Useful resins include a normal-phase, reversed-phase, ion exchange or size exclusion resin. In one embodiment, at least one resin is a reversed-phase resin, or at least one other resin is a strong cation exchange resin. At least one column may comprise a filter at an outlet or inlet of the at least one column or an in-line precolumn or guard column. The first and second resin may be directly and sequentially adjoined.

A method of detecting a molecular component of a sample according to the present method comprises (a) fractionating a sample with a first LC column comprising a first resin connected in tandem to a second LC column comprising a second resin, (b) loading a fraction of molecules eluted from the second column onto a third LC column comprising a third resin that is operably connected to the second column, (c) eluting a fraction of the molecules loaded onto the third column, and (d) analyzing the fraction with a spectrometer that is operably linked to the third column, where the first, second and third resins have distinct separation characteristics, and where the analysis provides detection of at least one molecular component of the sample. The method of the invention may comprise using a spectrometer having the same characteristics as set forth above.

The sample to be analyzed using the method of the present invention may be biological in origin or may be an environmental sample. When the sample is biological in origin, it may be blood, plasma, serum, lymph, excretia, an exudate, synovial fluid, vitreous fluid, a whole cell, a cellular extract, a whole organism, tissue, or a biopsy sample. The sample may be from an individual, and the presence, absence or change in the level of expression of a molecular component of the sample, which may be a circulating protein, may be indicative or diagnostic of a change in the physiological condition of the individual. In one embodiment, the physiological condition of the individual may reflect the presence of systemic inflammatory response syndrome or sepsis in the individual. The sample may be pretreated to remove at least one contaminant, which may involve chemical or enzymatic modification of at least one molecular component of the sample. The pretreatment itself may comprise dialysis, filtration, ultra-filtration, centrifugation, ultra-centrifugation, differential precipitation, or organic extraction. Alternatively, or in addition, the pretreatment may involve immunodepletion of at least one component on the sample prior to fractionating the sample with the first liquid LC column, where the immunodepleted component is albumin, an immunoglobulin, α-1 antitrypsin, α-2 macroglobulin, transferrin or haptoglobin-type 2-1. In one embodiment, analyzing the fraction with a spectrometer comprises using an algorithm to identify a circulating protein.

### BRIEF DESCRIPTION OF THE DRAWINGS

FIG. 1A is a schematic illustration of reverse phase (RP)-Strong Cation Exchange (SCX)-reverse phase (RP) 3D liquid chromatography separation.

FIG. 1B is a plot of data generated by analysis with an electrospray ionization (ESI) mass spectrometer according to FIG. 1A.

### DETAILED DESCRIPTION OF THE INVENTION

The present invention improves the resolution of molecules in a sample by providing multidimensional liquid chromatographic fractionation of the sample, prior to further separation of the molecular constituents of the sample by spectrometry. The LCⁿ apparatus of the present invention takes advantage of a first and second column to fractionate molecules based on different physical properties. For example, the first and second column may separate molecules on the basis of hydrophobicity (e.g., with a RP column) and net charge (e.g., with a SCX column), respectively. The first two columns may be configured in tandem, with the first and second resins directly adjoining one another, to provide a rapid, in-line means of initial fractionation of molecules in a sample, even though a tandem arrangement does not allow a truly orthogonal separation of molecules in the sample.

The present invention substantially improves molecular resolution by providing at least one additional LC column that further resolves molecules eluted from the first two columns. Molecules eluted from the at least one additional column are inserted into a spectrometer for final resolution of the molecular components. As a result of the at least third dimension of liquid chromatography added by the present invention, the overall complexity of the sample fraction that is analyzed in any single mass spectrometer run is reduced, allowing more components to be resolved from each other and increasing the dynamic range of resolution. Peak capacity may be increased as well, particularly in an embodiment where the additional column(s) comprise a high-resolution, analytical column.

Various combinations of suitable liquid chromatography resins and geometries for the LC columns of the LCⁿ apparatus are possible, provided that the combination provides at least three different separation characteristics (i.e., “dimensions”). A “separation characteristic” can relate to physical basis by which the resin resolves and separates molecules, such as by net charge, size or hydrophobicity. A combination of resins in the present invention thus could include three resins that separate molecules by different physical characteristics, such as a combination of size exclusion, ion exchange and reversed-phase resins. A difference in “separation characteristics” also can refer to a difference in the number of theoretical plates, N, of the column, as discussed further below. Thus, the present combination of resins could include two types of resins rather than three, where a third column has a geometry providing a higher number of theoretical plates, giving the third column greater resolution and separation characteristics than either the first or second columns.

An in-line trapping column at the terminus of the second LC column may be used in one embodiment of the present invention to facilitate the use of different flow rates and solvents for elution of additional columns within the LCⁿ apparatus. The trapping column alternately communicates with the outlet of the second LC column and the head of a third column. That is, the trapping column first may be positioned in tandem with the second column to trap molecules that are eluted from the second column. The trapping column then may be repositioned to the head of the third column so that the trapped molecules may be eluted from the trapping column onto the third column.

Use of the trapping column allows the third column to be eluted under conditions that otherwise might be incompatible with optimal separation by the first two columns. For instance, if the third column were positioned in tandem with an ion exchange second column, eluting the third column with a solute gradient also might cause some of the molecular species bound to the upstream ion exchange column to be eluted. Instead, the sample fraction bound to the trapping column may be eluted onto the third column without disturbing the fractionation of molecules provided by the first two columns.

Repositioning of the trapping column from the second to the third column may be accomplished by a switch-valve. The switch-valve may be may be fully automated to facilitate high-throughput use of the apparatus. High-pressure reversible fittings known in the art may connect the trapping column connection with the LC columns. These fittings may be designed and utilized by means well known in the art to minimize disruption in the fluid flow between the various columns to minimize peak broadening.

In one embodiment, the final LC column of the LCⁿ apparatus is operably connected to a mass spectrometer or NMR spectrometer. This operable connection may be achieved in a number of ways, provided only that molecules separated by the final column can be resolved by mass spectrometry or NMR spectrometry. For instance, a fraction eluted from the final column may be injected directly into an ion trap mass spectrometer by elctrospray ionization (ESI) as molecules are eluted from the final column. In this embodiment, the final column outlet is an orifice that may be heated in the range of 100-200° C. and may have an ESI voltage of 1-2 kV. Ions created by the ESI interface are stored in an ion trap before being separated by tandem mass spectrometry. Alternatively, a fraction of the final column may be applied to a support and ionized by a laser for time-of-flight analysis, as in a LCⁿ/MALDI-TOF-MS configuration. Other LC-MS interface configurations are possible.

Suitable mass spectrometers for the present invention thus include all mass spectrometry methods, such as electrospray ionization mass spectrometry (ESI-MS), ESI-MS/MS, ESI-MS/(MS)ⁿ (n is an integer greater than zero), matrix-assisted laser desorption ionization time-of-flight mass spectrometry (MALDI-TOF-MS), surface-enhanced laser desorption/ionization time-of-flight mass spectrometry (SELDI-TOF-MS), desorption/ionization on silicon (DIOS), secondary ion mass spectrometry (SIMS), quadrupole time-of-flight (Q-TOF), atmospheric pressure chemical ionization mass spectrometry (APCI-MS), APCI-MS/MS, APCI-(MS)ⁿ, atmospheric pressure photoionization mass spectrometry (APPI-MS), APPI-MS/MS, and APPI-(MS)ⁿ. Other suitable mass spectrometry methods may include, inter alia, quadrupole, fourier transform mass spectrometry (FTMS) and ion trap.

In another embodiment, the final LC column is operably linked to a NMR spectrometer. The operable connection between LC columns and NMR spectrometers, including those permitting in-line application of LC fractions to an NMR spectrometer, are known in the art and are described, for example, by Varian, Inc. (Palo Alto, Calif.) at http://www.varianinc.com/-cgi-bin/nav?products/nmr/accessory/lcnmr_ms&cid=NKKKPOHFN; Wang NMR, Inc. (North Canyons Parkway, Calif.) at http://www.wangnmr.com/LCNMR_technology.htm; Brucker BioSpin Corp. (Billerica, Mass.) at http://www.bruker-biospin.de NMR/hyphenation/caplc.html or http://www.bruker-biospin.de/NMR/hyphenation/lcnmrms.html.

The present apparatus may be used to resolve molecules in various samples. Accordingly, the present invention provides a method of analyzing a sample, comprising the application of a sample to the first and second columns to partially resolve molecules in the sample, then resolving fractions of molecules eluted from the first and second columns onto at least one additional column that is operably connected to the first and second columns. Fractions of molecules of the sample that are resolved by the at least one additional column are then analyzed by MS or NMR spectrometry.

The sample that is analyzed may be from any source. Because the present invention provides an improved dynamic range of molecular resolution, the sample may comprise a complex mixture of molecules of varying degrees of abundance. For example, the sample may be biological in origin. In one embodiment, the apparatus and method of the present invention are used to analyze the entire proteome of a complex biological sample. The biological samples may be from any biological fluid or tissue, which can include, but are not limited to, blood, plasma, serum, lymph, excretia, exudates, synovial or vitreous fluids, whole cells, cellular extracts, whole organisms, tissue, or biopsies. The sample alternatively may be an environmental sample, particularly a contaminated environmental sample, such as a sample from a chemical or biological spill, water samples, and the like. In another embodiment, the present invention is used to detect trace amounts of a particular substance within the sample. For example, the sample may be a preparation of a drug or enzyme that is suspected of containing a contaminant or impurity, or the sample may be a biological sample suspected of containing an illegal drug.

In one embodiment, a biological sample contains biomarkers for disease or other physiological conditions. The ability of the present apparatus and method to detect molecules with high resolution and over a wide dynamic range allows a relatively unbiased examination of the proteome of a given biological sample to detect various molecules that may be biomarkers for the given disease or physiological condition. That is, the presence or absence or change in abundance of particular ions may in mass spectra be indicative or diagnostic of a change in the physiological condition of the individual that provides a biological sample. In one embodiment, the present apparatus and method are used to detect low levels of circulating proteins, such as cytokines, from blood, which may be indicative of the given physiological condition. In another embodiment, the given physiological condition to be diagnosed or determined is sepsis or systemic inflammatory response syndrome.

Samples may be pretreated to remove certain components, particularly those that are not well separated under the applied separation conditions or that tend to clog liquid chromatography columns. For example, pretreatment may include protease or chemical digestion to reduce the molecular weight of the proteins in the sample. Generally, such treatments are designed to hydrolyze proteins at specific residues to generate consistently sized protein fragments. Other pretreatments include, but are not limited to, dialysis, filtration, ultra-filtration, centrifugation, ultra-centrifugation, differential precipitation, organic extraction, or nuclease treatment. Still other pretreatments include size exclusion chromatography, ion-exchange chromatography, PAGE, 2D-PAGE, or affinity chromatography.

In one embodiment, samples also may pretreated to increase the dynamic range of separation. For example, highly abundant proteins in plasma may be removed before resolving plasma samples with the present apparatus. Albumin, for instance, accounts for over half the protein present in plasma, yet changes in its relative abundance generally are hard to detect, and the large albumin peak(s) may obscure the presence of proteins with similar m/z values as albumin and its fragments. In one embodiment, pretreatment comprises removal of albumin by exposing a plasma sample to an antibody specific for albumin that removes most of the protein by forming a specific antibody complex. Proteins that likewise may be removed by immunodepletion include immunoglobulins, α-1 antitrypsin, α-2 macroglobulin, transferrin and haptoglobin-type 2-1, which together with albumin comprise about 85% of total plasma proteins.

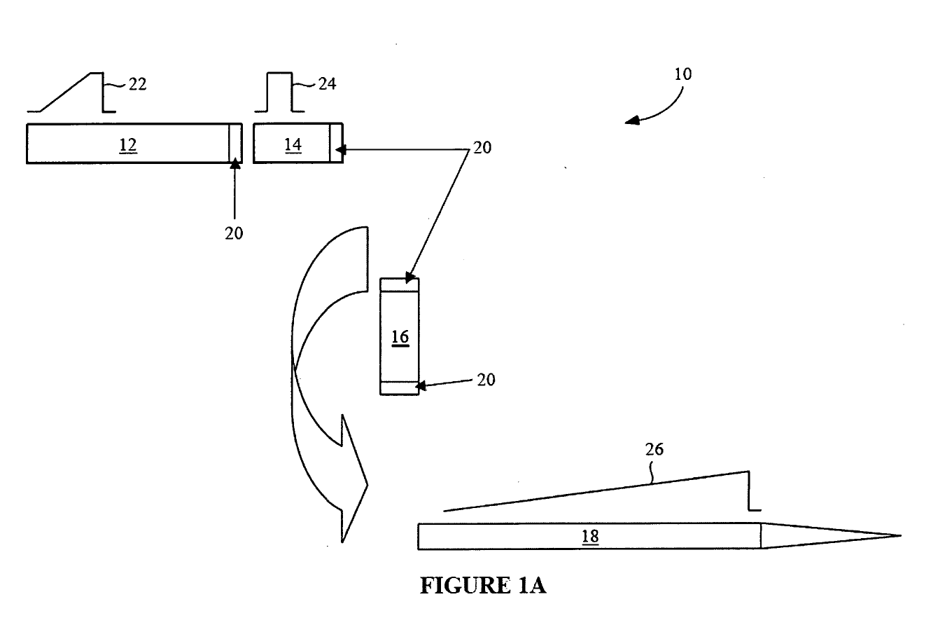

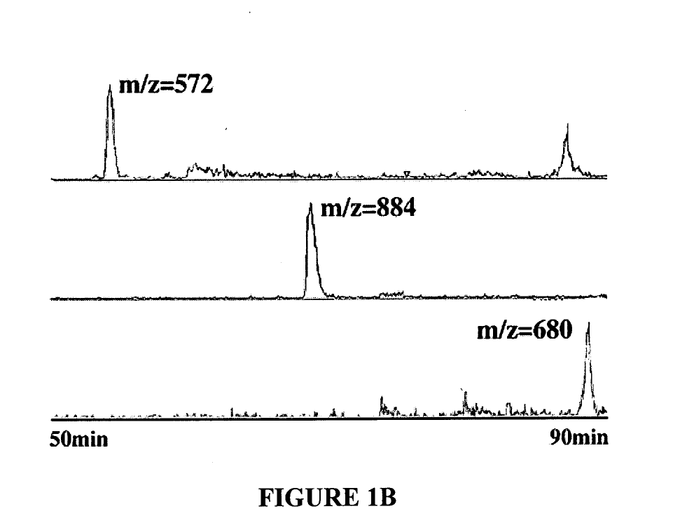

Samples may contain particulate or precipitated material, with or without pretreatment, that could interfere with the performance of the liquid chromatography columns. To ameliorate this possibility, the columns of the present invention may comprise filters, such as 0.5 μm filters, on the intake or outlet of the columns. In one embodiment, 0.5 μm filters are used at the outlet of the first and second columns and in the inlet and outlet of the trapping column, as shown in FIG. 1. Other techniques to remove interfering substances may be used, such as placing a guard column or precolumn upstream of the LC columns to adsorb particulates and strongly retained species. A guard column or precolumn may be used in-line to minimize disruption to the fluid flow and may be disposable.

The first and second columns of the liquid chromatography component of the present apparatus are connected in tandem. In one embodiment, the outlet of the first column feeds directly to the inlet of the second column. In another embodiment, the first and second columns share the same column housing, but the resins contained by the first and second columns are directly and sequentially adjoined. In yet another embodiment, the first and second resins of the two columns are in the form of a mixed bed resin, contained within the same column housing. Typically, in this latter embodiment the two resins are mixed anion and cation resins or are a mixture of different size exclusion resins. All of the above configurations fall within the meaning of “connected in tandem” for the purpose of the present invention.

Molecules partitioned by the first column are eluted onto the second column for further separation, to achieve the first two dimensions of separation provided by the present invention. The first and second columns provide distinct separation characteristics. In one embodiment, different separation characteristics are provided by first and second resins that interact with molecule in the fraction on the basis of different physical properties. Fractions of the molecules immobilized on the first resin may be eluted onto the second resin, where they are further fractionated. Alternatively, molecules may be separated without immobilization to resins, as in the case of size exclusion resins. In one embodiment, fractions are not collected, but the molecule instead are eluted continuously through the columns.

The first and second columns are eluted with a pump, which may be a high-pressure liquid chromatography pump (e.g., a quaternary HP 1100 HPLC pump, Hewlett-Packard, Palo Alto, Calif.). Means of interfacing high-pressure micro- and nano-tubing and columns to HPLC pumps are well understood in the art. For instance, tubing having an internal diameter in the range of 15-150 μm are useful for the present invention. The pump may be capable of variable flow rates, and it may be designed to mix the elution buffer in the form of a gradient. Continuous or stepwise gradients, including binary, ternary and quaternary solvent gradients, are standard means of eluting bound molecules that are well known in the art. A microcross (e.g., a PEEK microcross, Unimicro Technologies, Pleasanton, Calif.) may be used to split the flow from the HPLC pump. Means of connecting the various components of an apparatus for liquid chromatography to minimize disruption to the flow of the mobile phase are well known in the art.

Suitable resins for liquid chromatography are well known in the art and include, but are not limited to, normal-phase (adsorption), reversed-phase, ion exchange, size exclusion resins and the like. Each particular resin has known optimal solvent and elution conditions to resolve various molecules in a sample. Normal phase resins include absorbents such as silicon and aluminum oxides; compatible solvents are well known in the art and include hexane, chloroform, methanol, water, and the like. Reversed-phase columns suitable for the present invention include diol, cyanopropyl, aminopropyl, and silane (e.g., C₁, C₂, C₄, C₈, and C₁₈) resins. Suitable solvents and the effect of particular solvents on chromatographic performance for each of these resins are well known by the artisan in this field. Suitable ion exchange resins include strong cation exchange, strong anion exchange, weak cation exchange, weak anion exchange, and adsorbent resins. Examples of each of these types of resins are known in the art. Suitable matrixes for resins include hydrophilic polyether resins, polystyrene cross-linked with divinylbenzene, cross-linked agarose, polypropylene, hydrophilic acrylamidovinyl, methacrylate, hydrogel polymerized to ceramic beads, silica-dextran composites, polymer-grafted silica, spherical cross-linked cellulose beads, methacrylate co-polymers, hydrophilic gels, cellulose, and the like. Appropriate functional groups for ion exchange also are known in the art and include quaternary ammonium, methyl sulfonate, diethylaminoethyl, carboxymethyl, diethylamino-propyl, carboxylic acid, sulfonic acid, quaternary amine, timethylammoniumethyl, sulfoisobutyl, orthophosphate, and the like. The basis by which each ion exchange resin and functional group separates molecules in solution also is well known in the art. Suitable size exclusion resins include polydextrans, highly cross-linked polymers, silca gels polyacrylic acid, and other porous resins.

The at least one additional column provides a distinct separation characteristic from the first two columns, although it may contain a resin used in one of the first two columns. In this embodiment, the at least one additional column is used as an “analytical column,” which fractionates molecules with a resolution higher than that achieved by the first or second columns. Optimal conditions for high-resolution liquid chromatography are well known in the art and include modifying column geometry and flow rate of the mobile phase. A measure of the efficiency of a column is called a theoretical plate. The number of theoretical plates, N, is equal to 16(t_{R}/w_{b})², where t_{R} is the retention time, and w_{b} is the base width of the eluted solute peak. Increasing N thus can be accomplished by increasing the retention time, t_{R}, which is the time between injection and the appearance of a peak maximum (e.g., reducing the flow rate and/or using a longer column), and/or by decreasing the peak width (e.g., minimizing flow heterogeneities and wall effects in the fluid flow through the LC apparatus and/or reducing dead volumes where fluid mixing can occur). Peak capacity, the number of equally well-resolved peaks (n) that can be fit in a chromatogram between the holdup volume and some upper limit in retention, also can be improved by the same techniques that increase N, since peak capacity is proportional to (1+0.25[N^{1/2} ln(1+kₙ)]), where kₙ is the retention factor for peak n. In one embodiment, an analytical column of the present invention is eluted in a solute gradient at a flow rate of nL/min (e.g., 10, 20, 30, 50, 100, 200, 300, 400, 500 or 1000 nL/min), where the first and second columns are run at a flow rate of μL/min (e.g., 5, 10, 15, 20, 30, 40, 50 or 100 μL/min). Finally, the geometry of the analytical column can be altered in a predictable manner to optimize N. For example, a 5 μm porous packing in a 15 cm×4.6 mm column provides 10,000-12,000 theoretical plates. Other combinations of flow rates and geometries are possible and can be deduced by those of skill in the relevant art.

Ions that have been generated by mass spectrometry may be analyzed in a number of ways to deduce the molecular components of the sample. Typically, ions are resolved on the basis of their relative abundance (e.g., determined by their intensity) as a function of their mass-to-charge ratio, m/z. A protein or peptide component of a sample may be broken into various fragments, and the identity of the protein or peptide may be inferred from the collection of fragments appearing in the mass spectrum. In one embodiment, a mass spectrum is compared to a database containing entries of known proteins. For instance, the SEQUEST computer program may be used to identify proteins by searching against the NCBI nonredundant protein database containing tens of thousands of FASTA entries. Protein identification may depend of particular criteria, allowing identification within a given range of confidence.

SEQUEST is only one of the algorithms that can be used to identify a protein or peptide present in the sample from the ions resolved in a mass spectrum. In another embodiment, a pattern recognition algorithm, such as a neural network, may be used to identify sets of fragments that correlate with known protein fragment patterns. Confidence levels of identification may be set to identify proteins that yield fragment patterns falling within 10% of a predicted m/z ranges, for example.

The principles of the present invention are further described in the following illustrative, non-limiting example.

### EXAMPLE

Three-Dimensional Liquid Chromatography (RP-SCX-RP)/ESI MS:

The present example illustrates one configuration that may be used overcome the challenge of sample complexity. In the present example, depicted in FIG. 1A, the apparatus 10 utilizes the high resolving power of reversed-phase separation by combining a 2D on-line fractionation column 12,14 (RP1-SCX) to an analytical reversed-phase column 18 (RP2). The LCⁿ apparatus comprises two HPLC pumps (not illustrated) (one for the RP1-SCX column and one for the RP2 column), four micro- and nano-flow LC columns constructed in-house, and a switch valve. (See U.S. patent application Ser. No. 10/704,758, incorporated herein by reference in its entirety.)

Plasma samples were collected from 25 patients with systemic inflammatory response syndrome (SIRS) and 25 patients with sepsis. Samples were collected upon the day of entry into the present study (“day 1”), upon the day when the onset of sepsis was clinically suspected (“T₀”), and 24 or 48 hours prior to T₀ (“T₋₂₄” and “T₋₄₈,” respectively). 50 μl was taken from each individual sample of the SIRS group from Day 1; the 50 μl aliquots were pooled and divided into 20 separate batches. This process was repeated for the sepsis group, giving 1×20 batches for Day 1 from the SIRS group and 1×20 batches for Day 1 of the sepsis group. This process then was repeated for the T₀ and T₋₂₄ and T₋₄₈ samples, giving 4×20 batches from sepsis patients and 4×20 batches from SIRS patients.

Immunodepletion was performed with a Multiple Affinity Removal System column (Agilent Technologies, Inc., Palo Alto, Calif.), which was used according to the manufacturer's instructions. At least 95% of the aforementioned six proteins were removed from the plasma samples using this system. For example, only about 0.1% of albumin remained in the depleted samples. Only an estimated 8% of proteins left in the samples represented remaining high abundance proteins, such as IgM and α-2 macroglobulin. Fractionated plasma samples were then denatured, reduced, alkylated and digested with trypsin using procedures well-known in the art. About 2 mg of digested proteins were obtained from each pooled sample and subjected to LCⁿ/MS/MS analysis.

1 mg of the digested proteins from each pooled sample were loaded onto the first dimension reversed-phase (RP1) column 12 to be pre-fractionated based on hydrophobicity. The RP1 column, depicted as element 12 in FIG. 1A, was a C18 reversed-phase column 10 cm in length with an internal diameter of 500 μm. All together, five fractions were eluted off RP1 over 10 min at a flow rate of 10 μL/min, using acetonitrile (ACN) step gradients 22 of 0-10%, 10-20%, 20-30%, 30-40%, and 40-80%.

Each fraction eluted from RP1 was then further fractionated by an SCX column 14 based on the net charge of the peptides. The SCX column 14 was 4 cm long with an internal diameter of 500 μm. Each fraction eluted off the RP1 column was further fractionated into at least eight fractions by the SCX column. Fractions were eluted from the SCX column over 5 min at a flow rate of 10 μL/min with an ammonium acetate step gradients 24 contained 0 mM, 20 mM, 40 mM, 60 mM, 80 mM, 100 mM, 250 mM, and 1M ammonium acetate. All together, a total of 40 fractions off the SCX column were loaded onto the RP2 column 18. Each fraction eluted from the SCX was bound to a downstream, in-line C18 reversed-phase trap column, depicted by the vertical column element 16 in FIG. 1A. The trap column was 4 cm long with an internal diameter of 250 μm. For each fraction eluted from SCX, the trap column was disconnected from the outlet of SCX and repositioned to the head of RP2 using a switch valve, as represented by the arrow in FIG. 1A.

The RP2 column 18 was a C18 reversed-phase column 20 cm long with an internal diameter of 100 μm. The RP2 column was eluted with a continuous ACN gradient 26 for 150 min at 300 nL/min. While the gradient used to elute RP2 provided a solvent concentration range equivalent to that used to elute RP1, the separation characteristics of the two columns were distinct, based on differences in column geometry, elution profile, and flow rate between RP1 and RP2.

The RP2 column was operably linked to an Agilent MSD/trap ESI-ion trap mass spectrometer operating at a spray voltage of 1000-1500 V. Mass spectra were generated in an m/z range of 200-2200 Da. In some cases, data dependent scan and dynamic exclusion were applied to achieve higher dynamic range, according to methods well known in the art and described, for example, in Davis et al., “Towards defining the urinary proteome using liquid chromatography-tandem mass spectrometry II. Limitations of complex mixture analyses.” Proteomics 1: 108-17 (2001).

The runtime for each fraction was about 2.5 hours and total runtime for each sample was about three days. About 150,000 MS/MS spectra were collected over this three-day period. The whole process was fully automated and required no human intervention. The component ions of the sample fractions could be detected as part of a single, complex total ion chromatogram (TIC). Alternatively, the mass spectrometer could be used to detect a single ion species from the complex mixture, using methods well known in the art. Such extract ion chromatograms (EIC) also are shown in FIG. 1B. Notice the sharp chromatogram peaks in the EICs (the basewidth of the peaks was only about 1 min.), which demonstrates the high resolving power of the reverse phase separation, as applied in this embodiment of the present invention.

About 1.5 gigabytes of information were obtained for every sample that was analyzed in the MS/MS mode. In total, some 50 gigabytes of information were collected. Spectra were analyzed using Spectrum Mill v 2.7 software (Copyright© 2003 Agilent). The MS-Tag database-searching algorithm (Millennium Pharmaceuticals, Cambridge, Mass.) was used to match MS/MS spectra against a National Center for Biotechnology Information (NCBI) database of human non-redundant proteins. A cutoff score equivalent to 95% confidence was used to validate the matched peptides, which were then assembled to identify proteins present in the samples. Proteins that were detectable using the present method were present in plasma at a concentration of ˜1 ng/mL, covering a dynamic range in plasma concentration of about six orders of magnitude.

A semi-quantitative estimate of the abundance of detected proteins in plasma was obtained by determining the number of mass spectra that were “positive” for the protein. To be positive, an ion feature has an intensity that is detectably higher than the noise at a given m/z value in a spectrum. In general, a protein expressed at higher levels in plasma will be detectable as a positive ion feature or set of ion features in more spectra. With this measure of protein concentration, it is apparent that various proteins were differentially up-regulated or down-regulated in the SIRS group versus the sepsis group. The differential expression of proteins found even in minute quantities in the samples is expected to provide an unprecedented ability to differentiate patients with sepsis and SIRS prior to the clinical suspicion of sepsis.

In summary, a reversed-phase gradient (e.g., 0-10% ACN) is run through the RP1-SCX-trap 12, 14, 16, which elutes a fraction of the peptides in the sample from RP1 to SCX. A salt step (e.g., 20 mM ammonium acetate) is then run through the RP1-SCX-trap, and an even smaller fraction of the peptides in the sample is eluted from SCX to the trap column 16. The trap column 16 is switched from the high flow pump loop to the nano-flow pump loop, and a shallow reversed-phase gradient is run through the trap-RP2 16, 18, which is operably linked to the mass spectrometer.

The foregoing detailed description of the preferred embodiments of the invention exemplifies principles' of the invention and does not limit the invention to the disclosed specific embodiments. A skilled artisan may make numerous variations of these embodiments without departing from the spirit of the invention.

What is claimed is:

1. A liquid chromatograph spectrometer comprising:
a) a first liquid chromatography (LC) column comprising a first resin connected in tandem to a second LC column having an outlet and comprising a second resin;
b) a third LC column having an outlet and an inlet, and comprising a third resin; and
c) a spectrometer operably connected to the third column outlet;
wherein the first, second and third resins have distinct separation characteristics, and wherein the third LC column inlet is operably connected to the second LC column outlet.

2. The liquid chromatograph spectrometer of claim 1, wherein the spectrometer comprises a mass spectrometer.

3. The liquid chromatograph spectrometer of claim 2, wherein the mass spectrometer comprises an electrospray ionization mass spectrometer, a matrix-assisted laser desorption ionization time-of-flight mass spectrometer, a surface-enhanced laser desorption/ionization time-of-flight mass spectrometer, a desorption/ionization on silicon spectrometer, a secondary ion mass spectrometer, a quadrupole time-of-flight spectrometer, an atmospheric pressure chemical ionization mass spectrometer, an atmospheric pressure photoionization mass spectrometer, a quadrupole spectrometer, a fourier transform mass spectrometer, or an ion trap.

4. The liquid chromatograph spectrometer of claim 1, wherein the spectrometer comprises a NMR spectrometer.

5. The liquid chromatograph spectrometer of claim 1, wherein the operable connection between the second and third LC columns comprises a trapping column containing a trapping resin, which alternately communicates with the second LC column outlet and the third LC column inlet, wherein a fraction of molecules eluted from the second resin is capable of being contained within the trapping column when the trapping column communicates with the second LC column, and wherein the trapping resin and third resin bind the molecule on the basis of the same physical characteristic.

6. The liquid chromatograph mass spectrometer of claim 5, wherein the operable connection further comprises an automated mechanism for moving the trapping column from the second column outlet to the third column inlet.

7. The liquid chromatograph spectrometer of claim 1, wherein the liquid chromatograph spectrometer comprises four operably linked LC columns, each possessing a distinct separation characteristic.

8. The liquid chromatograph spectrometer of claim 7, wherein the liquid chromatograph spectrometer comprises five operably linked LC columns, each possessing a distinct separation characteristic.

9. The liquid chromatograph spectrometer of claim 1, wherein the third LC column is an analytical column that fractionates molecules with a resolution higher than that achieved by the first or second LC columns.

10. The liquid chromatograph spectrometer of claim 1, wherein the resins comprise a normal-phase, reversed-phase, ion exchange or size exclusion resin.

11. The liquid chromatograph spectrometer of claim 10, wherein at least one resin comprises a reversed-phase resin.

12. The liquid chromatograph spectrometer of claim 11, wherein at least one other resin comprises a strong cation exchange resin.

13. The liquid chromatograph spectrometer of claim 1, wherein at least one column comprises a filter at an outlet or inlet of the at least one column.

14. The liquid chromatograph spectrometer of claim 1, further comprising an in-line precolumn or guard column.

15. The liquid chromatograph spectrometer of claim 1, wherein the first and second resin are directly and sequentially adjoined.

16. A method of detecting a molecular component of a sample, comprising:
a) fractionating a sample with a first liquid chromatography (LC) column comprising a first resin connected in tandem to a second LC column comprising a second resin;
b) loading a fraction of molecules eluted from the second column onto a third LC column comprising a third resin that is operably connected to the second column;
c) eluting a fraction of the molecules loaded onto the third column; and
d) analyzing the fraction with a spectrometer that is operably linked to the third column,
wherein the first, second and third resins have distinct separation characteristics, and wherein the analysis provides detection of at least one molecular component of the sample.

17. The method of claim 16, wherein the spectrometer comprises a mass spectrometer.

18. The method of claim 17, wherein the mass spectrometer comprises an electrospray ionization mass spectrometer, a matrix-assisted laser desorption ionization time-of-flight mass spectrometer, a surface-enhanced laser desorption/ionization time-of-flight mass spectrometer, a desorption/ionization on silicon spectrometer, a secondary ion mass spectrometer, a quadrupole time-of-flight spectrometer, an atmospheric pressure chemical ionization mass spectrometer, an atmospheric pressure photoionization mass spectrometer, a quadrupole spectrometer, a fourier transform mass spectrometry, or an ion trap.

19. The method of claim 16, wherein the spectrometer comprises a NMR spectrometer.

20. The method of claim 16, wherein the operable connection between the second and third LC columns comprises a trapping column containing a trapping resin, which alternately communicates with an outlet of the second LC column and an inlet of the third LC column, wherein a fraction of molecules eluted from the second resin is capable of being contained within the trapping column when the trapping column communicates with the second LC column, and wherein the trapping resin and third resin bind the molecule on the basis of the same physical characteristic.

21. The method of claim 20, wherein the operable connection further comprises an automated mechanism for moving the trapping column from the second column outlet to the third column inlet.

22. The method of claim 16, wherein the liquid chromatograph spectrometer comprises four operably linked LC columns, each possessing a distinct separation characteristic.

23. The method of claim 22, wherein the liquid chromatograph spectrometer comprises five operably linked LC columns, each possessing a distinct separation characteristic.

24. The method of claim 16, wherein the third LC column comprises an analytical column that fractionates molecules with a resolution higher than that achieved by the first or second LC columns.

25. The method of claim 16, wherein the resins comprise a normal-phase, reversed-phase, ion exchange or size exclusion resin.

26. The method of claim 25, wherein at least one resin comprises a reversed-phase resin.

27. The method of claim 26, wherein at least one other resin comprises a strong cation exchange resin.

28. The method of claim 16, wherein the first and second resin are directly and sequentially adjoined.

29. The method of claim 16, wherein the sample is biological in origin or is an environmental sample.

30. The method of claim 29, wherein the sample is biological in origin.

31. The method of claim 30, wherein the sample is blood, plasma, serum, lymph, excretia, an exudate, synovial fluid, vitreous fluid, a whole cell, a cellular extract, a whole organism, tissue, or a biopsy sample.

32. The method of claim 29, wherein the sample is from an individual.

33. The method of claim 32, wherein the presence, absence or change in the level of expression of the molecular component of the sample is indicative or diagnostic of a change in the physiological condition of the individual.

34. The method of claim 33, where the change in the physiological condition of the individual comprises the appearance of systemic inflammatory response syndrome or sepsis in the individual.

35. The method of claim 16, wherein the sample is pretreated to remove at least one contaminant.

36. The method of claim 35, wherein the pretreatment comprises chemical or enzymatic modification of at least one molecular component of the sample.

37. The method of claim 35, wherein the pretreatment comprises dialysis, filtration, ultra-filtration, centrifugation, ultra-centrifugation, differential precipitation, or organic extraction.

38. The method of claim 30, further comprising immunodepleting of at least one component on the sample prior to fractionating the sample with the first liquid LC column.

39. The method of claim 38, wherein the immunodepleted component is albumin, an immunoglobulin, α-1 antitrypsin, α-2 macroglobulin, transferrin or haptoglobin-type 2-1.

40. The method of claim 16, wherein the molecular component of the sample is a circulating protein.

41. The method of claim 40, wherein analyzing the fraction with a spectrometer comprises using an algorithm to identify the circulating protein.
